(19) United States
(12) Patent Application Publication
(10) Pub. No.: US 2019/0225869 A1
(43) Pub. Date: Jul. 25, 2019

(54) HIGH TEMPERATURE GRAVEL PACK FLUID

(71) Applicant: Halliburton Energy Services, Inc., Houston, TX (US)

(72) Inventors: Dipti SINGH, Kingwood, TX (US); Michael W. Sanders, Houston, TX (US); James W. Ogle, Livingston, TX (US)

(21) Appl. No.: 16/338,207

(22) PCT Filed: Oct. 31, 2016
(86) PCT No.: PCT/US2016/059800

§ 371 Date: Mar. 29, 2019

(51) Int. Cl. C09K 8/575; C09K 8/57; E21B 43/04; E21B 43/267

(52) U.S. Cl. CPC C09K 8/5756; C09K 8/572; C09K 2208/10; E21B 43/267; E21B 43/04

(57) ABSTRACT

Gravel pack fluids and methods of use thereof provides improve fluid suspension characteristics under extremely high temperatures, for example, from about 275° F. to 300° F. (135° C. to 149° C.) or higher. The disclosed the gravel pack fluids are able to achieve stability at these elevated temperatures by virtue of a gel composition having natural or synthetic hectorite nanoparticles added thereto. Such gravel pack fluids are especially useful for delivering proppant into a subterranean formation, gravel into a wellbore, and the like, in certain parts of the world known to have extremely high downhole temperatures. The disclosed gravel pack fluids are particularly useful for inclined and horizontal well applications, as well as applications that involve transporting particulates through alternate flow paths, such as shunt tubes, bypass conduits, and the like.

### TECHNICAL FIELD

The exemplary embodiments disclosed herein relate generally to fluids used in treating subterranean formations and, more specifically, to fluids used to transport particulates, such as gravel or proppant, in subterranean formations having extremely high static temperatures.

### BACKGROUND

Gravel packing is often employed in oil and gas wells to filter or otherwise prevent sand or other formation matter from being extracted together with formation fluids. The presence of the sand or other formation matter is due to certain formations being unconsolidated or only loosely consolidated, which allows the sand to be carried into the wellbore. In such situations, gravel or proppant may be pumped down the wellbore and used as a filtration media to block the sand from damaging or plugging the wellbore or production equipment. Typically, a sand control screen is positioned within the annulus around the wellbore and a gravel-carrying fluid is pumped down the well and into the annulus around the screen. Liquid from this gravel pack fluid is then absorbed into the formation and through the screen, leaving behind a barrier of gravel around the screen. The gravel acts as a filter that blocks the sand and other formation matter while allowing formation fluids to flow.

In gravel packing operations, it is important that the gravel pack fluid have sufficient viscosity to keep the gravel suspended in the fluid while at the same time allowing the fluid to be easily pumped downhole. Viscosity is generally defined as the ratio of shear stress to shear rate (i.e., velocity gradient). An overly high viscosity may reduce pumpability, making it more difficult to deliver the gravel pack fluid to the intended location. Conversely, if the viscosity is too low, the gravel may fall out of suspension and be inadvertently deposited in an unintended location. This unintended gravel deposition may be particularly problematic in narrow flow channels, such as downhole tools with alternate flow paths, including shunt tubes, bypass conduits, and the like.

To achieve the desired viscosity, various gel compositions or systems comprising polymers and biopolymers crosslinked with borate and metal crosslinkers are used as the gravel pack fluid. Such gravel pack fluids are generally stable under downhole temperatures ranging between about 100° F. to 250° F. (38° C. to 121° C.), with some gravel pack fluids remaining stable up to temperatures of about 275° F. (135° C.). However, a number of places around the world, such as certain oil fields in Southeast Asia (e.g., Thailand), Australia, and Norway, have downhole temperatures as high as 300° F. (149° C.) or higher. At these extreme temperatures, many polymers and biopolymers quickly degrade, causing the gravel pack fluids to become destabilized. When this happens, the gravel back fluids undergo premature viscosity reduction, resulting in gravel falling out of suspension and being inadvertently deposited in unintended locations.

Accordingly, a need exists for improved gravel pack fluids that are able to keep gravel in suspension under extremely high static temperatures, for example, from about 275° F. to 300° F. (135° C. to 149° C.) or higher.

### BRIEF DESCRIPTION OF THE DRAWINGS

For a more complete understanding of the exemplary disclosed embodiments, and for further advantages thereof, reference is now made to the following description taken in conjunction with the accompanying drawings in which:

FIG. 1 illustrates an exemplary well in which a high temperature gravel pack fluid according to the disclosed embodiments may be used;

FIG. 2A illustrates an exemplary high temperature gravel pack fluid according to the disclosed embodiments;

FIG. 2B illustrates a high temperature suspension capability of the exemplary gravel pack fluid according to the disclosed embodiments;

FIG. 3A illustrates another exemplary high temperature gravel pack fluid according to the disclosed embodiments;

FIG. 3B illustrates a high temperature suspension capability of the exemplary gravel pack fluid according to the disclosed embodiments; and

FIG. 4 illustrates a comparison of the exemplary gravel pack fluid according to the disclosed embodiments to other gravel pack fluids.

### DESCRIPTION OF EXEMPLARY EMBODIMENTS

The following discussion is presented to enable a person skilled in the art to make and use the exemplary disclosed embodiments. Various modifications will be readily apparent to those skilled in the art, and the general principles described herein may be applied to embodiments and applications other than those detailed below without departing from the spirit and scope of the disclosed embodiments as defined herein. Accordingly, the disclosed embodiments are not intended to be limited to the particular embodiments shown, but are to be accorded the widest scope consistent with the principles and features disclosed herein.

As alluded to above, embodiments disclosed herein relate to gravel pack fluids and methods of use thereof having improved fluid suspension characteristics. More specifically, the gravel pack fluids and methods disclosed herein employ gel compositions that are able to remain stable (i.e., keep gravel suspended) even under extremely high static temperatures, for example, from about 275° F. to 300° F. (135° C. to 149° C.) or higher. In some embodiments, the disclosed gel compositions are able to achieve stability at these elevated temperatures by the addition of natural or synthetic hectorite nanoparticles to the gel compositions.

Although the disclosed embodiments are described in terms of gravel pack fluids, those skilled in the art will understand that the principles and teachings discussed herein are equally applicable to any treatment fluid. The term “treatment fluid” as used herein refers to any fluid that is used to treat a subterranean formation. Examples may include fluids for delivering proppant into a subterranean formation, gravel into a wellbore, and the like. Likewise, reversing out excess treatment fluid is also more easily accomplished by virtue of the improved in-fluid suspension capability disclosed herein. The disclosed embodiments are particularly useful for inclined and horizontal well applications, as well as applications that involve transporting particulates through alternate flow paths, such as shunt tubes, bypass conduits, and the like.

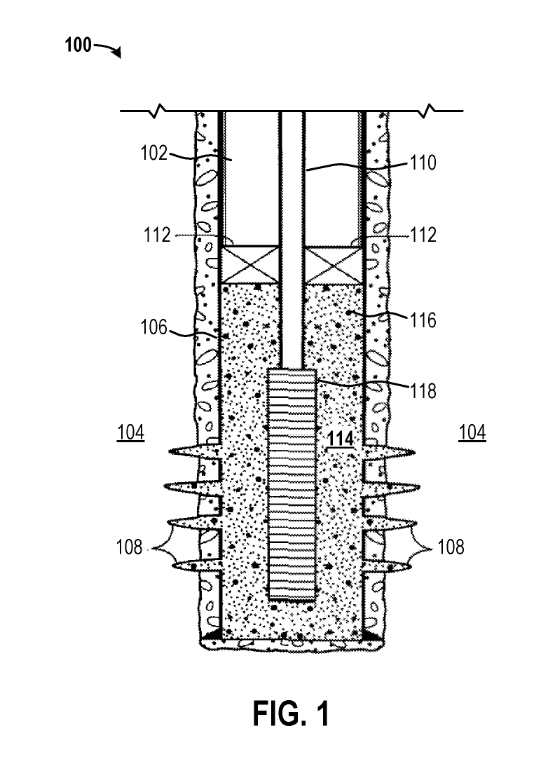

Referring now to FIG. 1, a partial view of a well 100 is shown in which a high temperature gravel pack fluid according to the embodiments disclosed herein may be used. Note that although the well 100 is shown as being substantially vertical, it should be understood that the embodiments disclosed herein are equally applicable to horizontal and inclined wells. The well 100 includes a wellbore 102 that extends into a subterranean formation 104 for extracting formation fluids (e.g., oil, gas, etc.) from the formation. Such a well 100 may be an open hole well or it may be a cased well, as evidenced by the presence of a casing 106 surrounding the wellbore 102. The casing 106 typically has perforations 108 created therein through which formation fluids may enter and be produced or extracted, as understood by those skilled in the art. Production of the formation fluids is typically conducted through a production tubing 110, with a packer 112 deployed as shown to isolate a desired production zone. A high temperature gravel pack fluid 114 having gravel 116 suspended therein is pumped into the production zone where the gravel 116 forms a barrier around a sand control screen 118 surrounding the production tubing 110.

In accordance with the disclosed embodiments, the high temperature gravel pack fluid 114 is specifically designed to keep gravel suspended even at extremely high static temperatures, for example, from about 275° F. to 300° F. (135° C. to 149° C.) or higher. And the gravel pack fluid 114 can keep the gravel suspended at these elevated temperatures for a long enough period of time to conduct downhole operations, such as forming a gravel pack in the wellbore, placing proppants in a subterranean formation, and the like, including operations where the gravel pack fluid passes through tools having alternate flow paths, such a sand control screen assembly, packer, completion tool, and bridge plug.

In some embodiments, the high temperature stability discussed above may be achieved by adding either natural or synthetic hectorite nanoparticles to conventional gel compositions commonly used for gravel pack fluids. The term “nanoparticles” as used herein refers to particles of about 1 nm to about 200 nm in diameter. The hectorite nanoparticles may be added in an amount ranging from about 1% by weight of the gel compositions to about 2% by weight of the gel compositions. Examples of synthetic hectorite nanoparticles may include THERMA-VIS™ nanoparticles available from Halliburton Energy Services, Inc. of Houston, Tex., and LAPONITE® nanoparticles available from BYK Additives Ltd. of Cheshire, United Kingdom. These hectorite nanoparticles are commonly used to achieve certain desirable properties in drilling mud, but have not heretofore been used to improve the stability of gravel pack fluids under extremely high static temperatures. When used thusly, the hectorite nanoparticles have been observed to enhance certain properties of gravel pack fluids, including apparent viscosity, static viscosity, particulate settling, and the like, allowing the gravel pack fluids to withstand extremely high static temperatures.

Suitable conventional gel compositions for use as described herein may include aqueous gel compositions having an aqueous base fluid, such as fresh water, saltwater (e.g., water containing one or more salts dissolved therein), brackish water, brine (e.g., saturated salt water), seawater, or any combination thereof. Any suitable source of water may suffice, provided that it does not contain components that adversely affect the stability of the gel compositions described herein. The pH range of the aqueous gel composition is preferably from about 6 to about 7, but may be adjusted as needed, among other things, to activate a crosslinking agent and/or to reduce the viscosity of the gel composition (e.g., activate a breaker or deactivate a crosslinking agent).

Non-aqueous base fluids may also be used in some embodiments, including alcohols such as methanol, ethanol, isopropanol, and other branched and linear alkyl alcohols, diesel, raw crude oils, condensates of raw crude oils, refined hydrocarbons such as gasoline, naphthalenes, xylenes, toluene and toluene derivatives, hexanes, pentanes, and ligroin, natural gas liquids, gases such as carbon dioxide and nitrogen gas, and any combinations thereof Alternatively, mixtures of the above non-aqueous fluids with water are also envisioned to be suitable for use in the gel compositions described herein, including mixtures of water and alcohol or several alcohols.

A gelling agent (i.e., viscosifier) may be added to the gel composition. In some embodiments, the gelling agents may be added at a concentration ranging from a lower limit of about 10 pptg (pounds per thousand gallons) to an upper limit of about 50 pptg, where the concentration may range from any lower limit to any upper limit therebetween. Gelling agents suitable for use in the gel compositions described herein may include biopolymers, synthetic polymers, or a combination thereof.

Examples of biopolymer gelling agents include diutan, xanthan, a guar gum, hydroxyethyl guar, hydroxypropyl guar, carboxymethyl guar, carboxymethylhydroxyethyl guar, carboxymethylhydroxypropyl guar (“CMHPG”), a cellulose derivative, hydroxyethyl cellulose (“HEC”), carboxyethyl cellulose, carboxymethyl cellulose (“CMC”), carboxymethylhydroxyethyl cellulose, scleroglucan, succinoglycan, and any derivative and/or combination thereof.

Examples of synthetic gelling agents may be homopolymers or copolymers with monomeric units that include acrylamide ethyltrimethyl ammonium chloride, acrylamide, acrylamido-alkyl trialkyl ammonium salts, methacrylamido-alkyl trialkyl ammonium salts, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacrylate, partially hydrolyzed acrylamide, 2-amino-2-methyl propane sulfonic acid, vinyl alcohol, sodium 2-acrylamido-2-methylpropane sulfonate, quaternized dimethylaminoethylacrylate, and any derivative and/or combination thereof.

The term “copolymer” encompasses polymers with two or more monomeric units, such as alternating copolymers, statistic copolymers, random copolymers, periodic copolymers, block copolymers (e.g., diblock, triblock, etc.) terpolymers, graft copolymers, branched copolymers, star polymers, and the like, or any hybrid thereof.

The disclosed gel compositions may also include a crosslinker or crosslinking agent in some embodiments. Suitable crosslinking agents may include borate ions, magnesium ions, zirconium IV ions, titanium IV ions, aluminum ions, antimony ions, chromium ions, iron ions, copper ions, magnesium ions, and zinc ions. These ions may be provided via any compound that is capable of producing one or more of these ions. Examples of such compounds include ferric chloride, boric acid, disodium octaborate tetrahydrate, sodium diborate, pentaborates, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, and titanium acetylacetonate, aluminum lactate, aluminum citrate, antimony compounds, chromium compounds, iron compounds, copper compounds, zinc compounds, and any combination thereof.

The crosslinking agents, when used, may be added at a concentration sufficient to provide the desired degree of crosslinking between molecules of the gelling agent. In some embodiments, the gel compositions described herein may include the crosslinking agents at a concentration ranging from a lower limit of about 0.05% by weight to an upper limit of about 5% by weight of the gel composition, where the concentration may range from any lower limit to any upper limit therebetween. The amount of crosslinking agent included may depend on, among other things, the downhole temperature, type of gelling agents used, molecular weight of the gelling agents, desired degree of viscosification, pH of the gel composition, or a combination thereof.

In some embodiments, the gel compositions disclosed herein may further include a breaker material. Examples of suitable breaker materials include one or more oxidative breakers known in the well treating industry.

Other suitable breaker materials which may be employed include acid, enzymes, or oxidizers. Examples of oxidizers include sodium persulfate, potassium persulfate, ammonium persulfate, ammonium peroxydisulfate, lithium or sodium hypochlorites, chlorites, and the like. Such breaker materials may be included at a concentration of between about 1% and 2% by weight of the gel composition.

The natural and synthetic hectorite nanoparticles disclose herein are not usually present in the form of discrete particles, but instead predominantly assume the form of agglomerates due to consolidation of the primary particles. Such agglomerates may reach diameters of several thousand nanometers, such that the desired characteristics associated with the nanoscale nature of the nanoparticles cannot be achieved. These particles may be deagglomerated, for example, by grinding or by dispersion in a suitable carrier medium, such as water or water/alcohol and mixtures thereof. The result is natural and synthetic nanoparticles that are more suitable for use with the disclosed gel compositions.

Other additives in addition to the above may also be added to the gel compositions disclosed herein in some embodiments. Examples of additives may include a weighting agent, an inert solid, a fluid loss control agent, an emulsifier, dispersion aid, corrosion inhibitor, emulsion thinner, emulsion thickener, surfactant, viscoelastic surfactant, biocide, stabilizer, chelating agent, scale inhibitor, gas hydrate inhibitor, mutual solvent, friction reducer, clay stabilizing agent, and the like, and any combination thereof. In some embodiments, the additives may be added at a concentration of about 0.05% by weight to an upper limit of about 5% by weight of the gel composition, where the concentration may range from any lower limit to any upper limit therebetween.

As discussed above, the gel compositions disclosed herein may be used with gravel pack fluids in downhole formations exhibiting extremely high static temperatures. In addition to gravel, other types of particulates may also be transported. The term “particulate” includes all known shapes of materials, including substantially spherical materials, fibrous materials, polygonal materials (such as cubic materials), and combinations thereof.

Examples of particulates suitable for use with the disclosed gel compositions include any material suitable for use in a subterranean formation, including sand, bauxite, ceramic materials, glass materials, polymer materials, polytetrafluoroethylene materials, nut shell fragments, cured resinous particulates comprising nut shell fragments, seed shell fragments, cured resinous particulates comprising seed shell fragments, fruit pit fragments, cured resinous particulates comprising fruit pit fragments, wood, composite particulates, and combinations thereof. Suitable composite particulates include a binder and filler material. Suitable filler materials include silica, alumina, fumed carbon, carbon black, graphite, mica, titanium dioxide, meta-silicate, calcium silicate, talc, zirconia, boron, fly ash, hollow glass microspheres, solid glass, and any combination thereof.

The size of the particulates may range from about 2 mesh to about 400 mesh on the U.S. Sieve Series scale in some embodiments. Examples of particulate size distribution ranges may include from 6/12 to 20/40 to 50/70 mesh and so on. The particulates may be included at a concentration ranging from a lower limit of about 0.025 ppg (pounds per gallon) to an upper limit of about 24 ppg, where the concentration may range from any lower limit to any upper limit therebetween.

To assist in understanding the disclosed embodiments, following are specific examples of preferred or representative gravel pack fluids. Those skilled in the art will understand that variations and modifications may be made without departing from the scope of the disclosed embodiments.

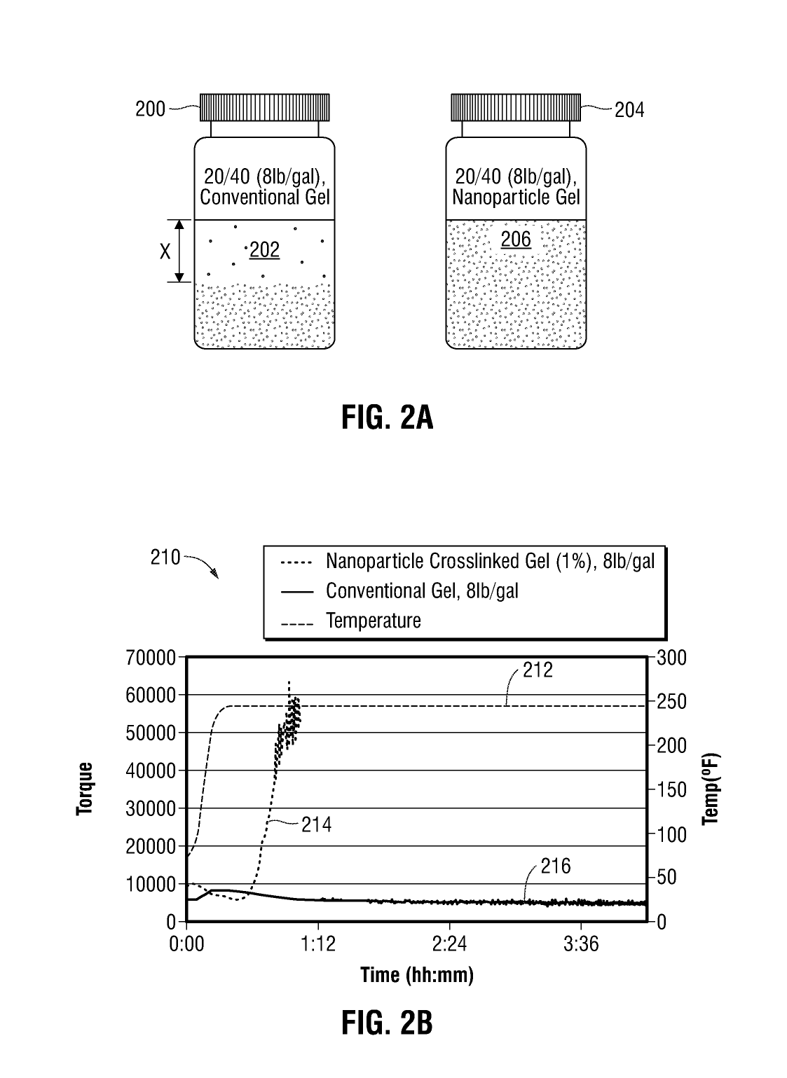

Referring now to FIG. 2A, an example of high temperature gravel pack fluid is shown according to the embodiments disclosed herein. Two jars are pictured in the figure, namely, a first jar 200 containing a conventional gravel pack fluid 202, and a second jar 204 containing an improved gravel pack fluid 206 according to the disclosed embodiments. Both the conventional gravel pack fluid 202 and the improved gravel pack fluid 206 comprise particulates, specifically gravel, having a size distribution range of 20/40 at a concentration of about 8 ppg in a gel composition composed of an aqueous base fluid and a biopolymer gelling agent (e.g., CMC). However, whereas the conventional gravel pack fluid 202 uses a conventional gel composition (i.e., no nanoparticles), the improved gravel pack fluid 206 uses a gel composition having about 1% by weight of synthetic hectorite nanoparticles crosslinked via an appropriate crosslinking agent (e.g., borate).

After preparation, both the conventional gravel pack fluid 202 and the improved gravel pack fluid 206 were subjected to rheological testing using a testing device (and method therefor) that is able to mimic common downhole conditions through which the gravel pack fluids would typically traverse. The particular rheological testing device (and method therefor) used in the example shown here is substantially the same as that described in commonly-assigned U.S. Pat. No. 6,782,735 entitled “Testing Device and Method for Viscosified Fluid Containing Particulate Material.” The testing was conducted at about 250° F. for a duration of approximately 4 hours.

As can be seen, the conventional gravel pack fluid 202 in the jar 200 on the left became destabilized during the testing and was not able to maintain the particulates in suspension. Consequently, the particulates have fallen out of suspension and settled on the bottom of the jar 200, leaving a layer of substantially particulate-free (e.g., within 5%) fluid on top of the particulates, indicated by line “X” in the figure. The improved gravel pack fluid 206, on the other hand, remained stable during the testing and was able to keep the particulates in suspension throughout the testing. Indeed, the improved gravel pack fluid 206 was observed to keep the particulates in suspension for up to 72 hours of testing in some instances.

The result of the above rheological testing is graphically depicted in FIG. 2B via a chart 210. In the chart 210, the vertical axis represents torque and the horizontal axis represents test time. According to the above-referenced commonly-owned patent, lower toque readings represent minimal resistance to flow, indicating the particulates are being suspended. The test temperature is indicated by the line labeled 212, the torque readings of the conventional gravel pack fluid 202 are indicated by the line labeled 214, and the torque readings of the improved gravel pack fluid 206 are indicated by the line labeled 216.

As can be seen, the particulates in both the conventional gravel pack fluid 202 and the improved gravel pack fluid 206 are in suspension initially, as indicated by the relatively low torque readings of lines 214 and 216 for about the first 15 minutes of the test. About half an hour later, after the 250° F. test temperature is reached, the particulates in the conventional gravel pack fluid 202 begins to fall out of suspension, as indicated by the rapid rise of line 214. About an hour into the test, the particulates in the conventional gravel pack fluid 202 fall almost entirely (e.g., within 5%) out of suspension, as indicated by the termination of line 214. Line 216, on the other hand, continues essentially unchanged for the duration of the test, indicating that the particulates in the improved gravel pack fluid 206 remain in suspension throughout the test.

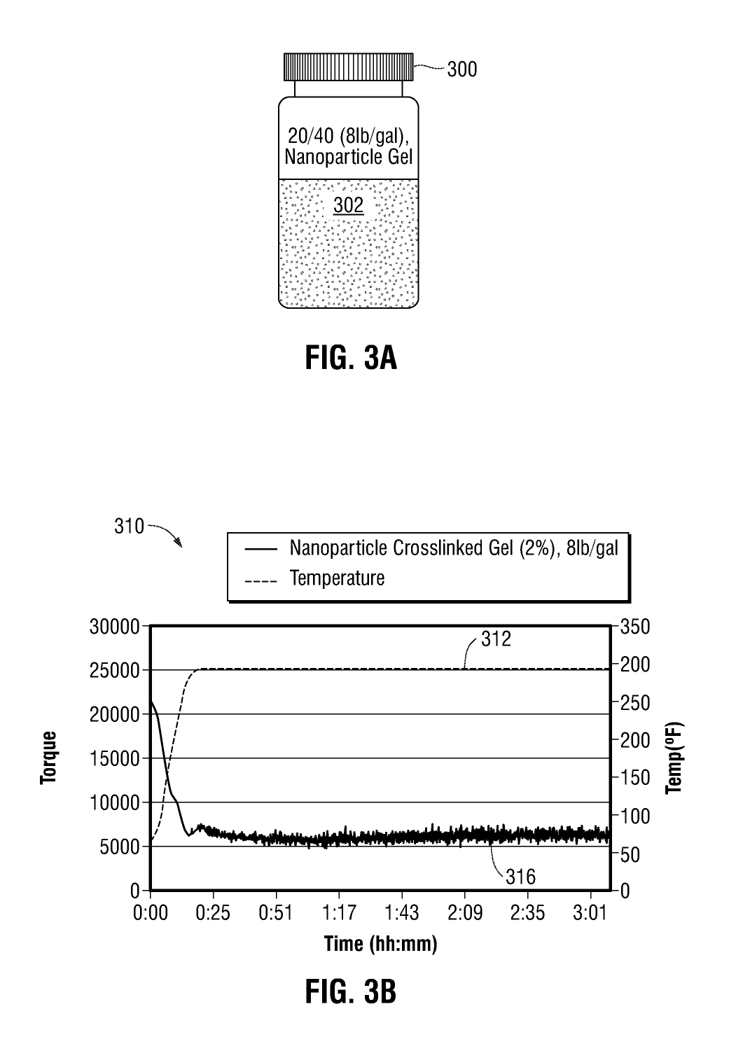

FIG. 3A illustrates another exemplary high temperature gravel pack fluid according to the embodiments. In this example, a jar 300 contains another improved gravel pack fluid 302 similar to the improved gravel pack fluid 206 of FIG. 2A (i.e., gravel size distribution range of 20/40 at a concentration of about 8 lbs/gal). However, the improved gravel pack fluid 302 in this example uses a gel composition having about 2% by weight of synthetic hectorite nanoparticles compared to 1% by weight for the improved gravel pack fluid 206.

The improved gravel pack fluid 302 was subsequently subjected to rheological testing using the same testing device (and method therefor), except the testing was conducted at about 300° F. for a duration of approximately 3 hours. As can be seen, the improved gravel pack fluid 302 with the 2synthetic hectorite nanoparticles performed equally well as the improved gravel pack fluid 206 with the 1% synthetic hectorite nanoparticles in terms of ability to remain stable (i.e., keeping particulates in suspension) throughout the testing. Indeed, the improved gravel pack fluid 302 was observed to keep the particulates in suspension for up to 72 hours of testing in some instances, even at the extremely high test temperature of 300° F.

The result of the above rheological testing is graphically depicted in FIG. 3B via a chart 310. As with the previous chart, the vertical axis in the chart 310 represents torque and the horizontal axis represents test time. The particulates in the improved gravel pack fluid 302 was able to remain in suspension at the elevated test temperature of 300° F., as indicated by the relatively little change occurring on line 316 after about the 20-minute mark.

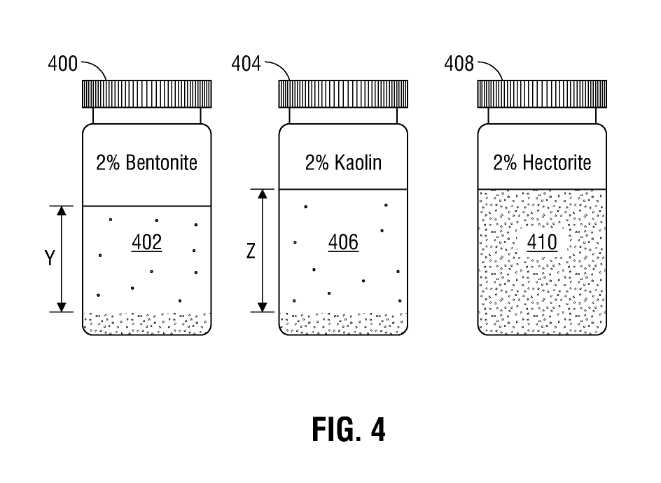

The ability of the gravel pack fluid disclosed herein to remain stable at extremely high static temperatures is an improvement even over gravel pack fluids having other types of nanoparticles, as depicted in FIG. 4. In FIG. 4 a comparison among gravel pack fluids having synthetic hectorite nanoparticles, synthetic bentonite nanoparticles, and synthetic kaolin nanoparticles is shown. There are three jars pictured in the figure. The first jar 400 contains a gravel pack fluid 402 comprising particulates, specifically gravel, having a size distribution range of 20/40 at a concentration of about 8 lbs/gal in a gel composition composed of an aqueous base fluid and a biopolymer gelling agent (e.g., CMC) and having 2% by weight of synthetic bentonite nanoparticles. The second jar 404 contains a gravel pack fluid 406 with the same particulates and gel composition, but having 2% by weight of synthetic kaolin nanoparticles. The third jar 408 contains an improved travel pack fluid 410 with the same particulates and gel composition, but having 2% by weight of synthetic hectorite nanoparticles.

As can be seen, the gravel pack fluids 402 and 406 having the bentonite and kaolin nanoparticles, respectively, in the first and second jars 400 and 404 both show particulates falling out of suspension when subjected to the same testing described above at a test temperature of 300° F. for approximately three hours. This falling out of suspension results in particulates settling at the bottom of the jars, leaving a layer of substantially particulate-free fluid (as indicated by the lines “Y” and “Z”) on top of the particulates. On the other hand, the gravel pack fluid 410 with the hectorite nanoparticles remained stable for the duration of the testing and was able to keep the particulates in suspension for throughout the testing.

Accordingly, as set forth above, the embodiments disclosed herein may be implemented in a number of ways. For example, in general, in one aspect, the disclosed embodiments may relate to a gel composition for use in a subterranean formation having a static temperature between about 275° F. to about 300° F. or higher. The gel composition may comprise an aqueous base fluid, a gelling agent, a cross-linking agent, and hectorite nanoparticles.

In accordance with any one or more of the foregoing embodiments, the hectorite nanoparticles include one of natural hectorite nanoparticles, synthetic hectorite nanoparticles, or a combination thereof.

In accordance with any one or more of the foregoing embodiments, the hectorite nanoparticles are present in the gel composition in an amount ranging from about 1% by weight of the gel composition to about 2% by weight of the gel composition.

In accordance with any one or more of the foregoing embodiments, the hectorite nanoparticle has a size in at least one dimension ranging from about 2 nm to about 500 nm.

In accordance with any one or more of the foregoing embodiments, the gelling agent includes one of a biopolymer, a synthetic polymer, or a combination thereof.

In accordance with any one or more of the foregoing embodiments, the crosslinking agent includes one of borate ions, magnesium ions, zirconium IV ions, titanium IV ions, aluminum ions, antimony ions, chromium ions, iron ions, copper ions, magnesium ions, zinc ions, or a combination thereof.

In general, in another aspect, the disclosed embodiments may relate to a gravel pack fluid comprising a gel composition according to any one or more of the foregoing embodiments.

The gravel pack fluid according to with any one or more of the foregoing embodiments, further comprising particulates suspended in the gel composition, the particulates ranging in size from about 2 mesh to about 400 mesh on the U.S. Sieve Series scale.

The gravel pack fluid according to with any one or more of the foregoing embodiments, wherein the particulates have a size distribution range of about 20/40 on the U.S. Sieve Series scale.

The gravel pack fluid according to with any one or more of the foregoing embodiments, wherein the particulates are present in the gravel pack fluid at a concentration of about 8 lbs/gal of the gel composition.

In general, in yet another aspect, the disclosed embodiments may relate to a method of depositing particulates in a wellbore having a static temperature between about 275° F. to about 300° F. or higher. The method comprises providing a sand control screen in the wellbore and pumping a gravel pack fluid down the wellbore, the gravel pack fluid comprising particulates suspended in a gel composition, the gel composition comprising an aqueous base fluid, a gelling agent, a cross-linking agent, and hectorite nanoparticles. The method further comprises depositing the particulates in the gravel pack fluid around the sand control screen.

In accordance with any one or more of the foregoing embodiments, the gravel pack fluid is pumped through an alternate flow path of a tool in the wellbore.

In accordance with any one or more of the foregoing embodiments, the tool includes one of a sand control screen assembly, a packer, a completion tool, or a bridge plug.

In accordance with any one or more of the foregoing embodiments, the alternate flow path includes one of a shunt tube or a bypass conduit.

In accordance with any one or more of the foregoing embodiments, the hectorite nanoparticles include one of natural hectorite nanoparticles, synthetic hectorite nanoparticles, or a combination thereof.

In accordance with any one or more of the foregoing embodiments, the hectorite nanoparticles are present in the gel composition in an amount ranging from about 1% by weight of the gel composition to about 2% by weight of the gel composition.

In accordance with any one or more of the foregoing embodiments, the hectorite nanoparticle has a size in at least one dimension ranging from about 2nm to about 500 nm.

In accordance with any one or more of the foregoing embodiments, the gelling agent includes one of a biopolymer, a synthetic polymer, or a combination thereof.

In accordance with any one or more of the foregoing embodiments, the crosslinking agent includes one of borate ions, magnesium ions, zirconium IV ions, titanium IV ions, aluminum ions, antimony ions, chromium ions, iron ions, copper ions, magnesium ions, zinc ions, or a combination thereof.

In accordance with any one or more of the foregoing embodiments, the particulates range in size from about 2 mesh to about 400 mesh on the U.S. Sieve Series scale.

In accordance with any one or more of the foregoing embodiments, the particulates have a size distribution range of about 20/40 on the U.S. Sieve Series scale.

In accordance with any one or more of the foregoing embodiments, the particulates are present in the gravel pack fluid at a concentration of about 8 lbs/gal of the gel composition.

While the invention has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention, which is set forth in the following claims.

1. A gel composition for use in a subterranean formation having a static temperature between about 275° F. to about 300° F. or higher, comprising:
an aqueous base fluid;
a gelling agent;
a cross-linking agent; and
hectorite nanoparticles.

2. The gel composition of claim 1, wherein the hectorite nanoparticles include one of natural hectorite nanoparticles, synthetic hectorite nanoparticles, or a combination thereof.

3. The gel composition of claim 1, wherein the hectorite nanoparticles are present in the gel composition in an amount ranging from about 1% by weight of the gel composition to about 2% by weight of the gel composition.

4. The gel composition of claim 1, wherein the hectorite nanoparticle has a size in at least one dimension ranging from about 2 nm to about 500 nm.

5. The gel composition of claim 1, wherein the gelling agent includes one of a biopolymer, a synthetic polymer, or a combination thereof.

6. The gel composition of claim 1, wherein the crosslinking agent includes one of borate ions, magnesium ions, zirconium IV ions, titanium IV ions, aluminum ions, antimony ions, chromium ions, iron ions, copper ions, magnesium ions, zinc ions, or a combination thereof.

7. (canceled)

8. The gravel pack fluid of claim 1, further comprising particulates suspended in the gel composition, the particulates ranging in size from about 2 mesh to about 400 mesh on the U.S. Sieve Series scale.

9. The gravel pack fluid of claim 8, wherein the particulates have a size distribution range of about 20/40 on the U.S. Sieve Series scale.

10. The method of claim 8, wherein the particulates are present in the gravel pack fluid at a concentration of about 8 lbs/gal of the gel composition.

11. A method of depositing particulates in a wellbore having a static temperature between about 275° F. to about 300° F. or higher, comprising:
providing a sand control screen in the wellbore; and
pumping a gravel pack fluid down the wellbore, the gravel pack fluid comprising particulates suspended in a gel composition, the gel composition comprising an aqueous base fluid, a gelling agent, a cross-linking agent, and hectorite nanoparticles;
wherein the particulates in the gravel pack fluid are deposited around the sand control screen.

12. The method of claim 11, wherein the gravel pack fluid is pumped through an alternate flow path of a tool in the wellbore.

13. The method of claim 12, wherein the tool includes one of a sand control screen assembly, a packer, a completion tool, or a bridge plug.

14. The method of claim 12, wherein the alternate flow path includes one of a shunt tube or a bypass conduit.

15. The method of claim 11, wherein the hectorite nanoparticles include one of natural hectorite nanoparticles, synthetic hectorite nanoparticles, or a combination thereof.

16. The method of claim 11, wherein the hectorite nanoparticles are present in the gel composition in an amount ranging from about 1% by weight of the gel composition to about 2% by weight of the gel composition.

17. The method of claim 11, wherein the hectorite nanoparticle has a size in at least one dimension ranging from about 2 nm to about 500 nm.

18. The method of claim 11, wherein the gelling agent includes one of a biopolymer, a synthetic polymer, or a combination thereof.

19. The method of claim 11, wherein the crosslinking agent includes one of borate ions, magnesium ions, zirconium IV ions, titanium IV ions, aluminum ions, antimony ions, chromium ions, iron ions, copper ions, magnesium ions, zinc ions, or a combination thereof.

20. The method of claim 11, wherein the particulates range in size from about 2 mesh to about 400 mesh on the U.S. Sieve Series scale.

21. The method of claim 20, wherein the particulates have a size distribution range of about 20/40 on the U.S. Sieve Series scale.

22. The method of claim 20, wherein the particulates are present in the gravel pack fluid at a concentration of about 8 lbs/gal of the gel composition.
